(19) United States
(12) Patent Application Publication
(10) Pub. No.: US 2005/0238249 A1
(43) Pub. Date: Oct. 27, 2005

(54) Radiographic apparatus and radiation detection signal processing method

(75) Inventor: Shoichi Okamura, Nara-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: SHIMADZU CORPORATION

(21) Appl. No.: 11/106,557

(22) Filed: Apr. 15, 2005

(30) Foreign Application Priority Data
Apr. 22, 2004 (JP) 2004-126578
Aug. 20, 2004 (JP) 2004-240723

(51) Int. Cl. G06K 9/36; G06K 9/00

(52) U.S. Cl. 382/274; 382/132

(57) ABSTRACT

Signal level differences occurring across a boundary extending vertically are also a type of signal level differences stemming from a distribution of signal levels of pixels. It is therefore possible to reduce the signal level differences of the pixels occurring in the horizontal direction of a pixel arrangement by applying an amount of correction obtained from statistics (mean values) relating to the distribution of signal levels of the pixels to the signal level of each pixel to correct each pixel. The correction is carried out only when a particular condition (condition A or B) that an absolute value of a difference between the mean values is at most a predetermined value is satisfied. It is therefore possible to avoid artifacts being generated by the correction carried out for locations where the absolute value of the difference between the statistics should exceed the predetermined value.

### BACKGROUND OF THE INVENTION

(1) Field of the Invention

This invention relates to a radiographic apparatus and a radiation detection signal processing method for obtaining radiographic images from radiation detection signals detected by irradiating an object under examination. More particularly, the invention relates to a technique for correcting pixels.

(2) Description of the Related Art

An example of radiographic apparatus is an imaging apparatus that obtains fluoroscopic images by detecting X rays. This apparatus used an image intensifier as an X-ray detecting device in the past. In recent years, a flat panel X-ray detector (hereinafter called simply “FPD”) has come to be used instead.

The FPD has a sensitive film laminated on a substrate, detects radiation incident on the sensitive film, converts the detected radiation into electric charges, and stores the electric charges in capacitors arranged in a two-dimensional array. The electric charges are read by turning on switching elements, and are transmitted as radiation detection signals to an image processor. The image processor obtains an image having pixels based on the radiation detection signals. Therefore, variations occur in the quantity of electric charges stored in detecting elements each forming the capacitor and switching element. This results in variations in signal level of the pixels based on the radiation detection signals of the respective detecting elements. In order to reduce such variations, for example, a calibration is carried out to adjust gains of amplifiers provided for the respective detecting elements to uniform their outputs.

On the other hand, such variations are known to be caused by time-dependent noise resulting from noise dependent on gate bus lines connected to the gates of the switching elements for switching the gates on and off. That is, a voltage applied successively to the gate bus lines arranged in rows to switch the gates on and off serially generates noise peculiar to each of the gate bus lines arranged in rows. The following is known to reduce this time-dependent noise.

According to the technique disclosed in Japanese Unexamined Patent Publication No. 2003-87656, an FPD is divided into a correction pixel area sealed off from radiation, and a normal, effective area for converting radiation into electric charges. An offset image is obtained without emitting radiation, which is subtracted from an original image resulting from radiation, to obtain an offset corrected image. In the correction pixel area of the offset corrected image, time-dependent noise is derived from a mean or a weighted mean of pixel data of the same gate bus line or every two gate bus lines turned on simultaneously. The time-dependent noise of each row is subtracted from each column.

However, even when such a calibration is carried out, variations in signal level, i.e. signal level differences, of pixels cannot always be eliminated. As shown in FIGS. 1A-1C, an image is formed of pixels arranged two-dimensionally. In this image, as shown in FIG. 1A, signal level differences of the pixels occur in a horizontal direction H of the pixel arrangement. More particularly, signal level differences occur between a right area R and a left area L across a boundary B_{V} extending vertically in FIG. 1A. The main cause of the signal level differences is, for example, the characteristic construction of the detector that a plurality of power sources share the areas in a sensor plane in supplying a voltage. Where two power sources share two areas divided vertically, as shown in FIG. 1B, signal level differences of the pixels occur in a vertical direction V of the pixel arrangement between an upper area U and a lower area D across a boundary B_{H} extending horizontally. Where different power sources share four, i.e. upper, lower, right and left, areas as shown in FIG. 1C, signal level differences occur in both the horizontal direction H and the vertical direction V. In this specification, the noise of the signal level differences shown in FIG. 1C is called “cross noise.”

### SUMMARY OF THE INVENTION

This invention has been made having regard to the state of the art noted above, and its object is to provide a radiographic apparatus and a radiation detection signal processing method capable of reducing signal level differences of pixels occurring in a horizontal direction or vertical direction of a pixel arrangement.

The above object is fulfilled, according to this invention, by a radiographic apparatus for obtaining radiographic images based on radiation detection signals, comprising a radiation emitting device for emitting radiation toward an object under examination; a radiation detecting device for detecting radiation transmitted through the object; a statistic calculating device for calculating statistics relating to a distribution of signal levels of pixels based on the radiation detection signals, the statistic calculating device being operable, when signal level differences occur across a boundary extending horizontally or vertically of a pixel arrangement, to calculate the statistics for two areas divided by the boundary; and a pixel correcting device for performing a correction of each pixel by applying an amount of correction relating to a difference between the statistics for the two areas to a signal level of each pixel to reduce the signal level differences.

With the radiographic apparatus according to this invention, statistics relating to a distribution of signal levels of the pixels based on radiation detection signals are calculated. When signal level differences occur across the boundary extending in the horizontal or vertical direction of the pixel arrangement, the statistic calculating device calculates statistics for the two areas divided by the boundary. The pixel correcting device applies an amount of correction relating to the difference between the statistics of the two areas to the signal level of each pixel so as to eliminate the signal level differences noted above. The signal level differences of the pixels occurring in the horizontal or vertical direction of the pixel arrangement are also a type of signal level differences stemming from a distribution of signal levels of the pixels. It is therefore possible to reduce the signal level differences of the pixels occurring in the horizontal or vertical direction of the pixel arrangement by applying the amount of correction obtained from the statistics relating to the distribution of signal levels of the pixels to the signal level of each pixel to correct each pixel.

The following inconvenience will arise when a correction is performed on the assumption that the two areas, upper and lower areas or right and left areas, divided by a boundary extending horizontally or vertically have substantially the same signal level. As shown in FIG. 10, where a boundary (referenced B_{V} in FIG. 10) crosses the structure of a patient M (e.g. body lines), areas opposed to each other across the boundary essentially have different signal levels. When the same correction is carried out in such a case on the assumption that the signal levels are substantially the same, artifacts will be generated to render the image unnatural.

In order to prevent such artifacts, the radiographic apparatus according to this invention, preferably, has the following construction.

The pixel correcting device is arranged to perform the correction only when a particular condition that an absolute value of the difference between the statistics is below a predetermined value is satisfied.

In this case, the pixel correcting device carries out the correction only when the particular condition is satisfied, the condition being that the absolute value of the difference between the statistics does not exceed a predetermined value. Thus, the processing is carried out without performing the correction at least for locations where the absolute value of the difference between the statistics should exceed the predetermined value, such as where, for example, the boundary noted above crosses the structure of the object under examination. As a result, it is possible to reduce the signal level differences of the pixels occurring in the horizontal or vertical direction of the pixel arrangement while avoiding artifacts being generated by the correction carried out for locations where the absolute value of the difference between the statistics should exceed the predetermined value.

In another aspect of the invention, a radiation detection signal processing method is provided for obtaining radiographic images based on radiation detection signals resulting from radiation emitted to and transmitted through an object under examination, the radiation detection signal processing method comprising the steps of calculating statistics relating to a distribution of signal levels of pixels based on the radiation detection signals, and when signal level differences occur across a boundary extending horizontally or vertically of a pixel arrangement, calculating the statistics for two areas divided by the boundary; and performing a correction of each pixel by applying an amount of correction relating to a difference between the statistics for the two areas to a signal level of each pixel to reduce the signal level differences.

With the radiation detection signal processing method according to this invention, since the signal level differences of the pixels occurring in the horizontal or vertical direction of the pixel arrangement are also a type of signal level differences stemming from a distribution of signal levels of the pixels, the amount of correction obtained from the statistics relating to the distribution of signal levels of the pixels is applied to the signal level of each pixel to correct each pixel. This reduces the signal level differences of the pixels occurring in the horizontal or vertical direction of the pixel arrangement.

In the radiation detection signal processing method according to this invention, the statistics are mean values of signal levels of at least part of the pixels, for example. The mean values are not limitative, but any statistics usually available may be used. Such a statistic is, for example, a median of the signal levels,

In the radiation detection signal processing method according to this invention, it is preferred that each pixel is corrected by applying the amount of correction to the signal level of each pixel, with a progressively smaller weighting with an increase in distance from the boundary to each pixel. The signal level differences appear notably near the boundary. The farther away the pixel is from the boundary, that is the longer the distance is from the boundary to the pixel, the less influence the signal level difference has on the signal level of that pixel. Thus, the smaller weight may be assigned for the longer distance from the boundary to the pixel, and each pixel may be corrected by applying such amount of correction to the signal level of the pixel. As a result, the signal level differences between the pixels can be reduced further.

In order to avoid artifacts, the radiation detection signal processing method according to this invention, preferably, performs the correction only when a particular condition that an absolute value of the difference between the statistics is below a predetermined value is satisfied.

In this case, since the correction is carried out only when the particular condition is satisfied, the condition being that the absolute value of the difference between the statistics does not exceed a predetermined value, the signal level differences of the pixels occurring in the horizontal or vertical direction of the pixel arrangement can be reduced while avoiding artifacts being generated by the correction carried out for locations where the absolute value of the difference between the statistics should exceed the predetermined value.

The correction is carried out only when the above particular condition is satisfied, but no correction is carried out at least for locations where the absolute value of a difference between statistics should exceed a predetermined value. A process different from the above correction may be carried out or no process may be carried out for such locations. The latter case, i.e. “no process may be carried out”, means that, when the particular condition is not satisfied, no correction is carried out and the signal level of each pixel is not changed, but the unchanged signal level is used as the signal level of the pixel.

In the radiation detection signal processing method for performing the correction only when such a particular condition is satisfied, in order to avoid artifacts, the statistics may be mean values of the signal levels, for example, and the particular condition may be that an absolute value of a difference between the mean values is at most 50. Another example of the particular condition is that the absolute value of the difference between the statistics has at most a fixed ratio to the smaller of the statistics for the two areas. Where the statistics are mean values of the signal levels, the particular condition is that an absolute value of a difference between the mean values is at most 0.1 times the smaller of the mean values. The correction process may be carried out when at least one of the several examples of particular conditions cited above is satisfied, or only when a plurality of particular conditions are all satisfied.

Also in the radiation detection signal processing method for performing the correction only when such particular conditions are satisfied, the statistics may be mean values of the signal levels, medians of the signal levels, modes of the signal levels, or weighted mean values of the signal levels. While the mean values are as described hereinbefore, the median is a value located in a middle position in a group of values of the signal levels. The mode is a value with a maximum count in a histogram. The weighted mean is a mean value with a weight varied according to the distance from the boundary. The predetermined value, preferably, is selected from the range of 25 to 100.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1A (PRIOR ART) is an explanatory view schematically showing an image to illustrate signal level differences of pixels occurring horizontally in the prior art;

FIG. 1B (PRIOR ART) is an explanatory view schematically showing an image to illustrate signal level differences of pixels occurring vertically in the prior art;

FIG. 1C (PRIOR ART) is an explanatory view schematically showing an image to illustrate signal level differences of pixels occurring both horizontally and vertically in the prior art;

FIG. 2 is a block diagram of a fluoroscopic apparatus in a first embodiment,

FIG. 3 is an equivalent circuit of a flat panel X-ray detector, seen in side view, used in the fluoroscopic apparatus in the first and second embodiments;

FIG. 4 is an equivalent circuit of the flat panel X-ray detector seen in plan view;

FIG. 5 is a flow chart of a series of signal processing performed by a statistic calculator and a pixel corrector of the apparatus in the first embodiment;

FIG. 6 is an explanatory view schematically showing an image to illustrate a signal processing in the first embodiment;

FIG. 7 is a block diagram of a fluoroscopic apparatus in the second embodiment;

FIG. 8 is a flow chart of a series of signal processing performed by a statistic calculator and a pixel corrector of the apparatus in the second embodiment;

FIG. 9 is an explanatory view schematically showing an image to illustrate a signal processing in the second embodiment; and

FIG. 10 is an explanatory view schematically showing an image including a portion of intersection between the structure of an object under examination and a boundary where signal level differences occur.

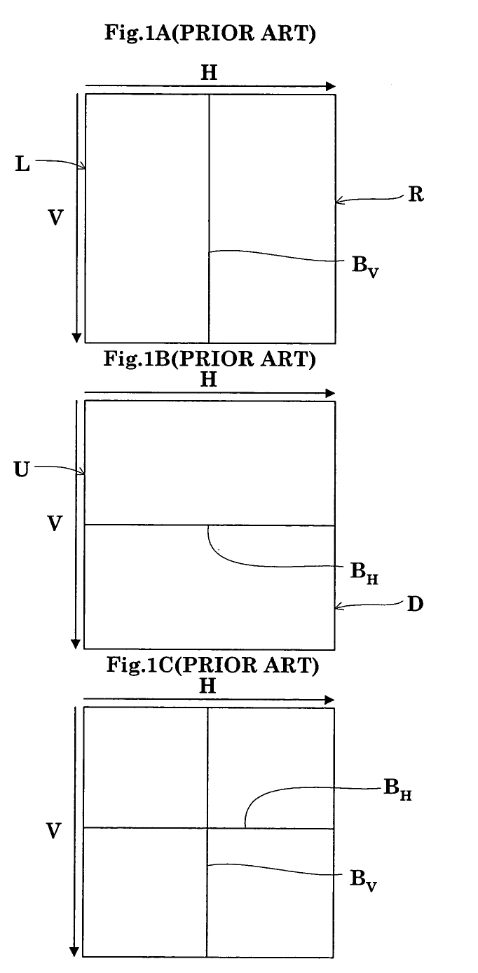

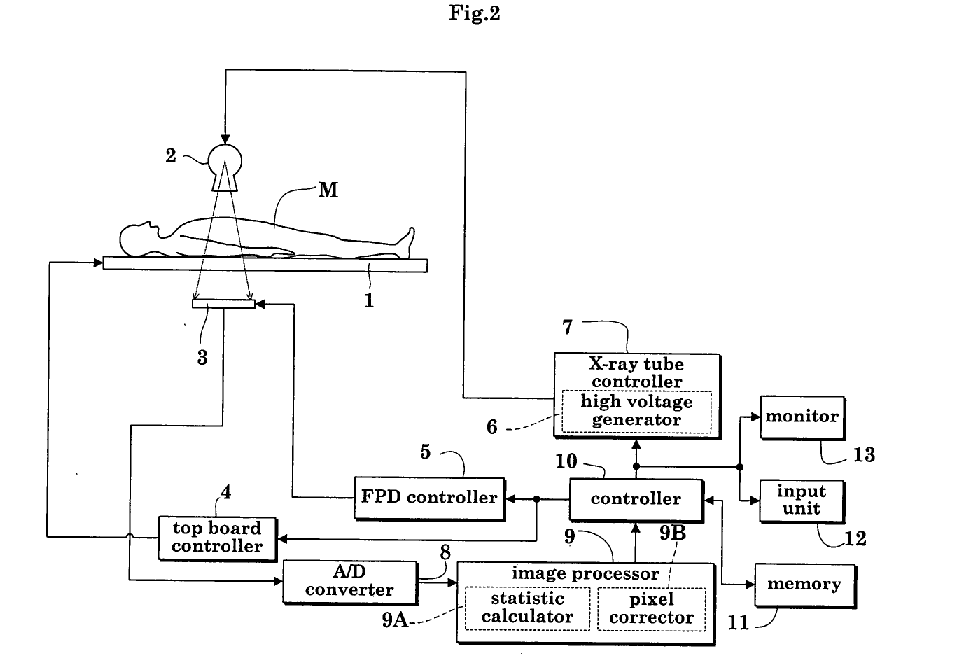

### DESCRIPTION OF THE PREFERRED EMBODIMENTS

Preferred embodiments of this invention will be described in detail hereinafter with reference to the drawings.

### First Embodiment

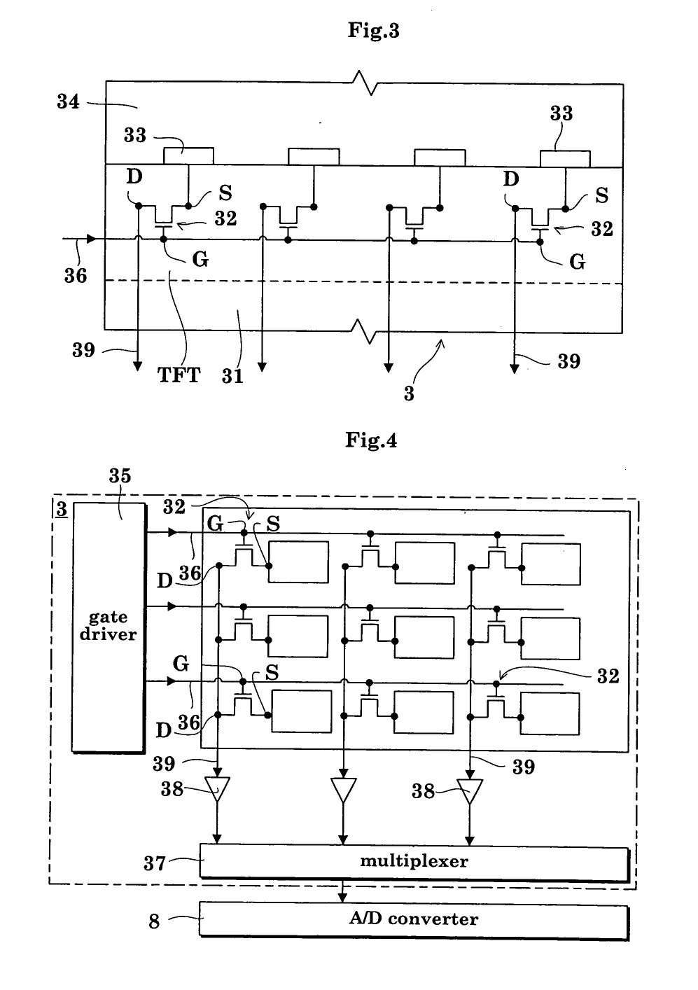

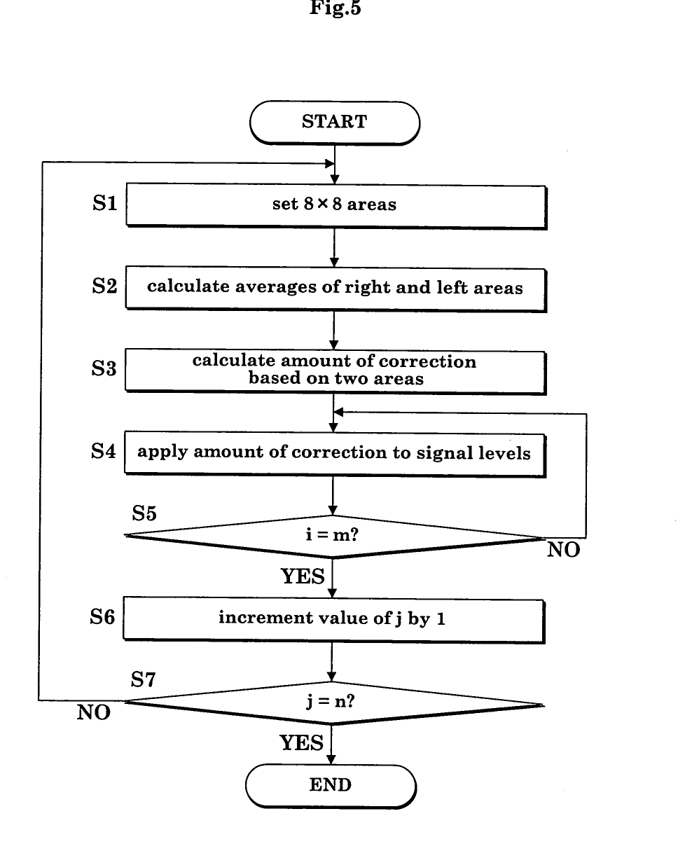

FIG. 2 is a block diagram of a fluoroscopic apparatus in the first embodiment. FIG. 3 is an equivalent circuit of a flat panel X-ray detector, seen in side view, used in the fluoroscopic apparatus in the first and second embodiments. FIG. 4 is an equivalent circuit of the flat panel X-ray detector seen in plan view. The first embodiment, and also the second embodiment to follow, will be described, taking a flat panel X-ray detector (hereinafter called “FPD” as appropriate) as an example of the radiation detection device, and a fluoroscopic apparatus as an example of the radiographic apparatus.

As shown in FIG. 2, the fluoroscopic apparatus in the first embodiment includes a top board 1 for supporting a patient M, an X-ray tube 2 for emitting X rays toward the patient M, and an FPD 3 for detecting X rays transmitted through the patient M. The X-ray tube 2 corresponds to the radiation emitting device in this invention. The FPD 3 corresponds to the radiation detecting device in this invention.

The fluoroscopic apparatus further includes a top board controller 4 for controlling vertical and horizontal movements of the top board 1, an FPD controller 5 for controlling scanning action of FPD 3, an X-ray tube controller 7 having a high voltage generator 6 for generating a tube voltage and tube current for the X-ray tube 2, an analog-to-digital converter 8 for fetching charge signals from the FPD 3 and digitizing the charge signals into X-ray detection signals, an image processor 9 for performing various processes based on the X-ray detection signals outputted from the analog-to-digital converter 8, a controller 10 for performing an overall control of these components, a memory 11 for storing processed images, an input unit 12 for the operator to input various settings, and a monitor 13 for displaying the processed images and so on.

The top board controller 4 controls movements of the top board 1, such as moving the top board 1 horizontally to place the patient M in an imaging position, vertically moving and/or rotating the top board 1 to set the patient M to a desired position, horizontally moving the top board 1 during an imaging operation, and horizontally moving the top board 1 away from the imaging position after the imaging operation. The FPD controller 5 controls scanning action by moving the FPD 3 horizontally or revolving the FPD 3 about the body axis of patient M. The high voltage generator 6 generates a tube voltage and tube current for the X-ray tube 2 to emit X rays. The X-ray tube controller 7 controls scanning action by moving the X-ray tube 2 horizontally or revolving the X-ray tube 2 about the body axis of patient M, and controls setting of a coverage of a collimator (not shown) disposed adjacent the X-ray tube 3. In time of scanning action, the X-ray tube 2 and FPD 3 are moved while maintaining a mutually opposed relationship, so that the FPD 3 may detect X rays emitted from the X-ray tube 2.

The controller 10 has a central processing unit (CPU) and other elements. The memory 11 has a storage medium, typically a ROM (Read-Only Memory) or RAM (Random Access Memory. The input unit 12 has a pointing device, typically a mouse, keyboard, joy stick, trackball and/or touch panel. The fluoroscopic apparatus creates images of the patient M, with the FPD 3 detecting X rays transmitted through the patient M, and the image processor 9 performing an image processing based on the X rays detected.

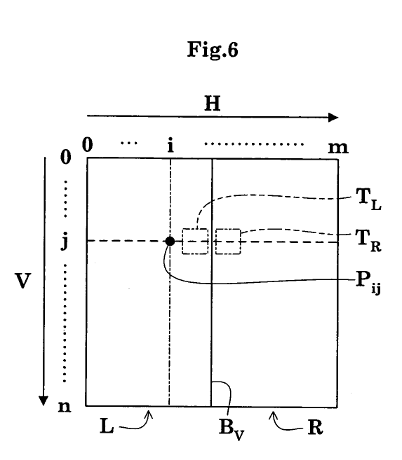

The image processor 9 includes a statistic calculator 9A for calculating mean values as statistics relating to a distribution of signal levels of pixels as described hereinafter, and a pixel corrector 9B for correcting each pixel by applying an amount of correction relating to a difference between the mean values to the signal level of each pixel so as to eliminate signal level differences of the pixels occurring horizontally or vertically of the pixel arrangement. The statistic calculator 9A and pixel corrector 9B are also in the form of a central processing unit (CPU) and so on. Specific functions of the statistic calculator 9A and pixel corrector 9B will be described hereinafter with reference to the flow chart shown in FIG. 5 and the explanatory view shown in FIG. 6. The statistic calculator 9A corresponds to the statistic calculating device in this invention. The pixel corrector 9B corresponds to the pixel correcting device in this invention.

As shown in FIG. 3, the FPD 3 includes a glass substrate 31, and thin film transistors TFT formed on the glass substrate 31. As shown in FIGS. 3 and 4, the thin film transistors TFT comprise numerous (e.g. 1,024×1,024) switching elements 32 arranged in a two-dimensional matrix of rows and columns. The switching elements 32 are formed separate from one another for respective carrier collecting electrodes 33. Thus, the FPD 3 is also a two-dimensional array radiation detector.

As shown in FIG. 3, an X-ray sensitive semiconductor 34 is laminated on the carrier collecting electrodes 33. As shown in FIGS. 3 and 4, the carrier collecting electrodes 33 are connected to the sources S of the switching elements 32. A plurality of gate bus lines 36 extend from a gate driver 35, and are connected to the gates G of the switching elements 32. On the other hand, as shown in FIG. 4, a plurality of data bus lines 39 are connected through amplifiers 38 to a multiplexer 37 for collecting charge signals and outputting as one. As shown in FIGS. 3 and 4, each data bus line 39 is connected to the drains D of the switching elements 32.

With a bias voltage applied to a common electrode not shown, the gates of the switching elements 32 are turned on by applying thereto (or reducing to 0V) the voltage of the gate bus lines 36. The carrier collecting electrodes 33 output charge signals (carriers) converted from X rays incident on the detection surface through the X-ray sensitive semiconductor 34, to the data bus lines 39 through the sources S and drains D of the switching elements 32. The charge signals are provisionally stored in capacitors (not shown) until the switching elements are turned on. The amplifiers 38 amplify the charge signals read out to the data bus lines 39, and the multiplexer 37 collects the charge signals, and outputs them as one charge signal. The analog-to-digital converter 8 digitizes the outputted charge signal, and outputs it as an X-ray detection signal.

Next, a series of signal processing by the statistic calculator 9A and pixel corrector 9B in the first embodiment will be described with reference to the flow chart shown in FIG. 5 and the explanatory view shown in FIG. 6. This processing will be described by taking for example a correction made when signal level differences of the pixels occur in the horizontal direction H of the pixel arrangement as shown in FIG. 6.

As shown in FIG. 6, the pixels are arranged two-dimensionally in m columns (m being a natural number) and n rows (n being a natural number). It is assumed that signal level differences occur between a right area R and a left area L across a boundary B_{V} extending vertically in FIG. 6. It is assumed also that i satisfies 1≦i≦m, and j satisfies 1≦j≦n.

(Step S1) Set 8×8 Areas

Pay attention to a pixel Pᵢⱼ which is the intersection of an i-th pixel column and a j-th pixel row. Two areas are set, including the j-th pixel row, adjoining the boundary B_{V}, and each having eight pixels arranged horizontally and eight pixels arranged vertically (these areas being hereinafter called “8×8 areas”). In FIG. 6, reference T_{R} indicates the 8×8 area in the right area R, and reference T_{L} indicates the 8×8 area in the left area L. The number of pixels in each area is not limited to 8×8, but may be 4×4, 2×8 or 8×2, for example.

(Step S2) Calculates Mean Values of Right and Left Areas

Next, the statistic calculator 9A (FIG. 2) calculates a mean value of signal levels of the pixels in the 8×8 area T_{R} in the right area R, and a mean value of signal levels of the pixels in the 8×8 area T_{L} in the left area L. The mean value of the signal levels of the pixels in the 8×8 area T_{R} in the right area R is X_{R}, while the mean value of the signal levels of the pixels in the 8×8 area T_{L} in the left area L is X_{L}. The mean value may be an arithmetic mean of the signal levels of all the pixels in each of the areas T_{R} and T_{L}, or may be a geometric mean of the signal levels of all the pixels in each of the areas T_{R} and T_{L}. The mean values X_{R} and X_{L} calculated in step S2 corresponds to the statistics relating to a distribution of signal levels of the pixels in this invention.

(Step S3) Calculate Amount of Correction Based on Two Areas

A value is calculated for eliminating the signal level differences occurring in the horizontal direction H, based on the mean value X_{R} of the signal levels of the pixels in the 8×8 area T_{R} in the right area R and the mean value X_{L} of the signal levels of the pixels in the 8×8 area T_{L} in the left area L. Assuming this value to be an amount of correction X, the amount of correction X is derived from the following equation (1):
X=(X_{L}−X_{R})/2 (1)

(Step S4) Apply Amount of Correction to Signal Levels

To eliminate the signal level differences occurring in the horizontal direction H, the amount of correction X determined in step S3 is applied to the signal levels of all the pixels in the j-th pixel row {P₁ⱼ, P₂ⱼ, . . . , Pᵢⱼ, . . . , P₍ₘ₋₁₎ⱼ and Pₘⱼ} in the order of i=1, 2, . . . , m⁻¹ and m. This operation is carried out with the following conditions.

When applying the amount of correction X to the signal levels of the pixels in the j-th pixel row belonging to the left area L, the amount of correction X is subtracted from the signal levels of the pixels (Pᵢⱼ−X). When applying the amount of correction X to the signal levels of the pixels in the j-th pixel row belonging to the right area R, the amount of correction X is added to the signal levels of the pixels (Pᵢⱼ+X).

(Step S5) i=m?

As the amount of correction X is applied to the signal level of each of the pixels in the order of i=1, 2, . . . , m−1 and m, the pixel corrector 9B (FIG. 2) checks whether i=m has been reached. When i<m, the operation returns to step S4 to repeat steps S4 and S5 until i=m is reached. When i=m, the signal levels of all the pixels in the j-th pixel row {P₁ⱼ, P₂ⱼ, . . . , Pᵢⱼ, . . . , P₍ₘ₋₁₎ⱼ and Pₘⱼ} have been corrected by the amount of correction X applied thereto. Then, the operation moves to the next step.

(Step S6) Increment Value of j by 1

Steps S1-S5 described above are executed also for the signal levels of each pixel row {P₁ⱼ, P₂ⱼ, . . . , Pᵢⱼ, . . . , Pᵢ₍ₙ₋₁₎ and Pᵢₙ} in the order of j=1, 2, . . . , n−1 and n. That is, the value of j is incremented by one for steps S1-S5.

(Step S7) j=n?

As the amount of correction X is applied to the signal level of each of the pixels in the order of j=1, 2, . . . , n−1 and n, the pixel corrector 9B (FIG. 2) checks whether j=n has been reached. When j<n, the operation returns to step S1 to repeat steps S1 et seq. until j=n is reached. When j=n, all the pixels in the image have been corrected, and the series of signal processing is ended.

With the apparatus in the first embodiment having the above construction, mean values X_{R} and X_{L} are calculated as statistics relating to a distribution of signal levels of the pixels based on X-ray detection signals obtained. When signal level differences occur across the boundary B_{V} extending in the vertical direction V of the pixel arrangement, the statistic calculator 9A calculates the mean values X_{R} and X_{L} for two areas (i.e. the right area R and left area L) divided by the boundary B_{V}. The pixel corrector 9B applies the amount of correction X relating to the difference (X_{L}−X_{R}) between the mean values of the two areas to the signal level of each pixel so as to eliminate the signal level differences noted above. The signal level differences of the pixels occurring in the horizontal direction H of the pixel arrangement are also a type of signal level differences stemming from a distribution of signal levels of the pixels. It is therefore possible to reduce the signal level differences of the pixels occurring in the horizontal direction H of the pixel arrangement by applying the amount of correction X obtained from the mean values X_{R} and X_{L} relating to the distribution of signal levels of the pixels to the signal level of each pixel to correct each pixel.

Since it is not necessary to provide the correction pixels disclosed in Japanese Unexamined Patent Publication No. 2003-87656 noted hereinbefore, versatility is increased with respect to radiation detecting devices represented by the FPD 3 or the like.

The same functions and effects are produced to cope with signal level differences occurring in the vertical direction. This is achieved by replacing the horizontal direction with the vertical direction in the flow chart of FIG. 5, setting 8×8 areas adjoining a boundary extending horizontally, calculating an amount of correction, and applying the amount of correction to the signal level of each pixel. In the case of cross noise, the same correction may be carried out for both horizontal and vertical directions to eliminate the cross noise.

### Second Embodiment

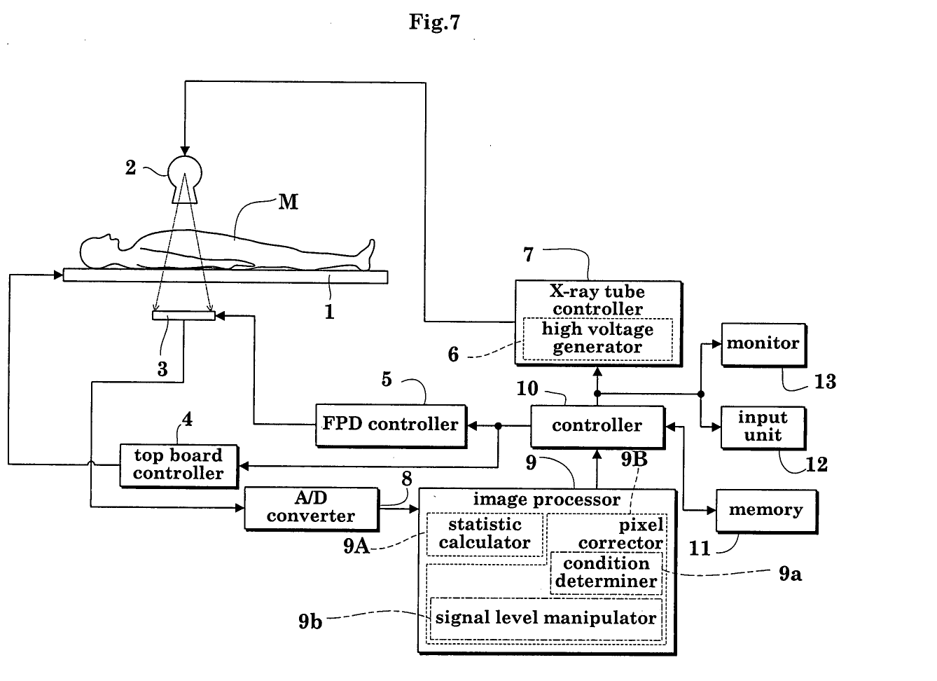

FIG. 7 is a block diagram of a fluoroscopic apparatus in the second embodiment. Parts identical to those of the first embodiment are labeled with the same reference numbers, and are not described again.

In the fluoroscopic apparatus in the second embodiment, as shown in FIG. 7, the pixel corrector 9B of the image processor 9 includes a signal level manipulator 9b having a function to apply an amount of correction to the signal level of each pixel to eliminate signal level differences of the pixels as in the first embodiment. In the second embodiment, the pixel corrector 9B further includes a condition determiner 9a for determining whether a particular condition described hereinafter is satisfied or not.

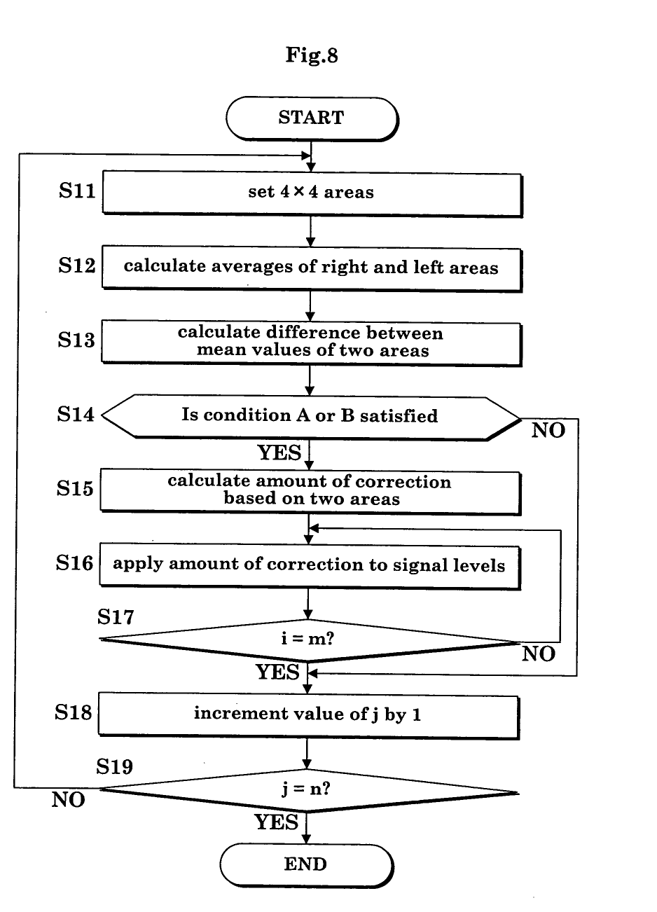

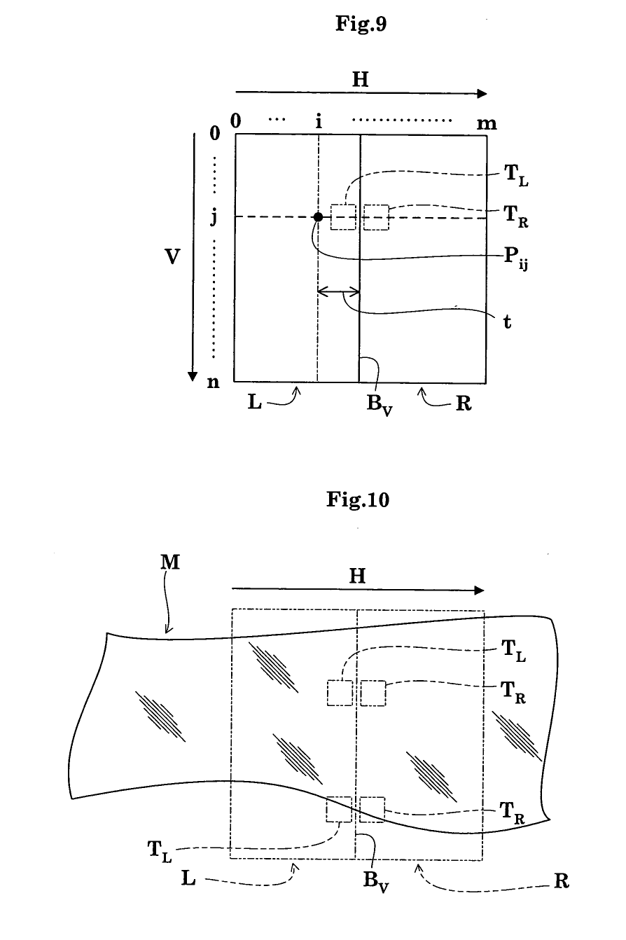

Next, a series of signal processing by the statistic calculator 9A and pixel corrector 9B in the second embodiment will be described with reference to the flow chart shown in FIG. 8 and the explanatory view shown in FIG. 9. This processing will be described by taking for example a correction made when signal level differences of the pixels occur in the horizontal direction H of the pixel arrangement as shown in FIG. 9.

(Step S1) Set 4×4 Areas

Pay attention to a pixel Pᵢⱼ which is the intersection of an i-th pixel column and a j-th pixel row. Two areas are set, including the j-th pixel row, adjoining the boundary B_{V}, and each having four pixels arranged horizontally and four pixels arranged vertically (these areas being hereinafter called “4×4 areas”). In FIG. 9, reference T_{R} indicates the 4×4 area in the right area R, and reference T_{L} indicates the 4×4 area in the left area L. The number of pixels in each area is not limited to 4×4, but may be 8×8 as in the first embodiment described hereinbefore, or 2×8 or 8×2, for example.

(Step S12) Calculates Mean Values of Right and Left Areas

Next, the statistic calculator 9A calculates a mean value of signal levels of the pixels in the 4×4 area T_{R} in the right area R, and a mean value of signal levels of the pixels in the 4×4 area T_{L} in the left area L. The mean value of the signal levels of the pixels in the 4×4 area T_{R} in the right area R is X_{R}, while the mean value of the signal levels of the pixels in the 4×4 area T_{L} in the left area L is X_{L}. The mean value may be an arithmetic mean of the signal levels of all the pixels in each of the areas T_{R} and T_{L}, or may be a geometric mean of the signal levels of all the pixels in each of the areas T_{R} and T_{L}.

(Step S13) Calculate Difference Between Mean Values of Two Areas

A difference is determined between the mean value X_{R} of the signal levels of the pixels in the 4×4 areas T_{R} in the right area R and the mean value X_{L} of the signal levels of the pixels in the 4×4 area T_{L} in the left area L, i.e. a difference in the mean value between the two areas (X_{L}−X_{R}).

(Step S14) Is Condition A or B Satisfied?

The condition determiner 9a of the pixel corrector 9B (FIG. 7) determines whether the absolute value of the difference between the mean values (X_{L}−X_{R}) calculated in step S13 satisfies a particular condition that it does not exceed a predetermined value. In this embodiment, the particular condition is condition A or condition B described hereinafter. When the absolute value of the difference satisfies at least one of these conditions A and B, the operation moves to step S15 and then to step S16 for carrying out a correction. Conversely, when the absolute value satisfies neither condition A nor condition B, the operation jumps to step S18, skipping step 15 for calculating an amount of correction and steps S16 and S17 for making the correction.

A. The absolute value of the difference between the mean values (X_{L}−X_{R}) is 50 or less.

When the mean value X_{R} is larger than the mean value X_{L}, the difference between the mean values (X_{L}−X_{R}) constitutes a negative, and therefore the absolute value of the difference is taken. Note that the mean values X_{R} and X_{L} are digital values since the signal levels of the pixels used as the basis for the mean values X_{R} and X_{L} have already been digitized by the analog-to-digital converter 8. Similarly, the absolute value of the difference between the mean values (X_{L}−X_{R}) is also a digital value. The numerical value “50” is a number represented in decimal notation, its actual digital value being “110010” in binary number.

B. The absolute value of the difference between the mean values (X_{L}−X_{R}) is 0.1 or less times the smaller mean value.

When the mean value X_{L} is larger than the mean value X_{R}, the absolute value of the difference between the mean values (X_{L}−X_{R}) is 0.1 or less times the smaller mean value X_{R}. When the mean value X_{R} is larger than the mean value X_{L}, the absolute value of the difference between the mean values (X_{L}−X_{R}) is 0.1 or less times the smaller mean value X_{L}. Note that the mean values X_{R} and X_{L} are digital values, and thus positive values.

(Step S15) Calculate Amount of Correction Based on Two Areas

When step S14 finds that the absolute value satisfies at least one of conditions A and B, a value is calculated for eliminating the signal level differences occurring in the horizontal direction H, based on the mean value X_{R} of the signal levels of the pixels in the 4×4 area T_{R} in the right area R and the mean value X_{L} of the signal levels of the pixels in the 4×4 area T_{L} in the left area L. Assuming this value to be an amount of correction X, the amount of correction X is derived from the following equation (11):
X={(X_{L}−X_{R})}/2×α^{t} (11)

In the above equation, α is less than one, and is set to 0.97 in this embodiment. Of course, α is not limited to 0.97, as long as it is less than one. Sign t is a distance (i.e. the number of pixels) from the boundary B_{V} to the pixel as shown in FIG. 9. The multiplication by a constitutes a weighting. That is, by raising a which is less than one to the t-th power, the smaller weight is applied for the longer distance t from the boundary B_{V} to the pixel, and the greater weight for the shorter distance t. In practice, the signal level differences appear notably near the boundary. The farther away the pixel is from the boundary, that is the longer the distance is from the boundary to the pixel, the less influence the signal level difference has on the signal level of that pixel. Therefore, a correction made without weighting may result in an excessive correction for pixels with minor influences of the signal level difference, i.e. for pixels distant from the boundary. Such excessive correction may be prevented by the above weighting.

(Step S16) Apply Amount of Correction to Signal Levels

This step the same as step S4 in the first embodiment, and will not be described again.

(Step S17) i=m?

This step is the same as step S5 in the first embodiment, and will not be described again.

(Step S18) Increment Value of j by 1

Steps S11-S17 described above are executed also for the signal levels of each pixel row {Pᵢ₁, Pᵢ₂, . . . , Pᵢⱼ, . . . , Pᵢ₍ₙ₋₁₎ and Pᵢₙ} in the order of j=1, 2, . . . , n−1 and n. That is, the value of j is incremented by one for steps S11-S17.

When neither of conditions A and B is satisfied and steps S15-S17 are skipped to make no correction, the value of j is incremented by one to make a shift to a next pixel row, whereby the conditions A and B are determined with respect to different parts. Thus, when neither of conditions A and B is satisfied, the operation jumps to step S18, and the following step, step S19, is executed in the same way as when at least one of conditions A and B is satisfied.

When neither of conditions A and B is satisfied, the operation skips steps S15-S17 to make no correction of the signal level of each pixel. Thus, the unchanged signal level is used as the signal level of each pixel.

(Step S19) j=n?

As the amount of correction X is applied to the signal level of each of the pixels in the order of j=1, 2, . . . , n−1 and n, whether j=n has been reached is checked. When j<n, the operation returns to step S11 to repeat steps S11 et seq. until j=n is reached. When j=n, all the pixels in the image have been corrected, and the series of signal processing is ended.

With the apparatus in the second embodiment having the above construction, the statistic calculator 9A calculates the mean values X_{R} and X_{L} for two areas (i.e. the right area R and left area L) divided by the boundary B_{V}, as in the first embodiment. The pixel corrector 9B applies the amount of correction X relating to the difference (X_{L}−X_{R}) between the mean values of the two areas to the signal level of each pixel so as to eliminate the signal level differences noted above. The signal level differences of the pixels occurring in the horizontal direction H of the pixel arrangement are also a type of signal level differences stemming from a distribution of signal levels of the pixels. It is therefore possible to reduce the signal level differences of the pixels occurring in the horizontal direction H of the pixel arrangement by applying the amount of correction X obtained from the mean values X_{R} and X_{L} relating to the distribution of signal levels of the pixels to the signal level of each pixel to correct each pixel.

The pixel corrector 9B carries out the correction described above only when the particular condition is satisfied, the condition being that the absolute value of the difference between the mean values does not exceed a predetermined value. Thus, the processing is carried out without performing the correction in steps S16 and S17 for locations where the absolute value of the difference between the mean values (X_{L}−X_{R}) should exceed the predetermined value, such as where, as shown in FIG. 10, for example, the boundary B_{V} described above crosses the structure of patient M (e.g. body lines). As a result, it is possible to reduce the signal level differences of the pixels occurring in the horizontal direction H of the pixel arrangement while avoiding artifacts being generated by the correction carried out for locations where the absolute value of the difference between the mean values (X_{L}−X_{R}) should exceed the predetermined value.

In the second embodiment, the particular conditions described above are A: the absolute value of the difference between the mean values (X_{L}−X_{R}) is 50 or less, and B: the absolute value of the difference between the mean values (X_{L}−X_{R}) is 0.1 or less times the smaller mean value. The correction is carried out when at least one of these conditions A and B is satisfied. Conversely, the correction is skipped when neither of the conditions A and B is satisfied.

This invention is not limited to the foregoing embodiments, but may be modified as follows:

(1) In each embodiment described above, the fluoroscopic apparatus has been described by way of example, in the first embodiment as shown in FIG. 2, and in the second embodiment as shown in FIG. 7. This invention may be applied also to a fluoroscopic apparatus mounted on a C-shaped arm, for example. This invention may be applied also to an X-ray CT apparatus.

(2) In each embodiment described above, the flat panel X-ray detector (FPD) 3 has been described by way of example. This invention is applicable to any X-ray detector having detecting elements arranged in a two-dimensional matrix defining pixels.

(3) In each embodiment described above, the X-ray detector for detecting X rays has been described by way of example. This invention is not limited to a particular type of radiation detector which may, for example, be a gamma-ray detector for detecting gamma rays emitted from a patient dosed with radioisotope (RI), such as in an ECT (Emission Computed Tomography) apparatus. Similarly, this invention is applicable to any imaging apparatus that detects radiation, as exemplified by the ECT apparatus noted above.

(4) In each embodiment described above, the FPD 3 is a direct conversion type detector with a radiation (X rays in each embodiment) sensitive semiconductor for converting incident radiation directly into charge signals. Instead of the radiation sensitive type, the detector may be the indirect conversion type with a light sensitive semiconductor and a scintillator, in which incident radiation is converted into light by the scintillator, and the light is converted into charge signal by the light sensitive semiconductor.

(5) In the first embodiment, the amount of correction X is derived from equation (1) (i.e. X=(X_{L}−X_{R})/2). In the second embodiment, the amount of correction X is derived from equation (11) (i.e. X={(X_{L}−X_{R})}/2×at). When applying the amount of correction X to the signal level of each pixel included in the j-th pixel row and belonging to the left area L, the amount of correction X is subtracted from the signal level of the pixel (Pᵢⱼ−X). When applying the amount of correction X to the signal level of each pixel included in the j-th pixel row and belonging to the right area R, the amount of correction X is added to the signal level of the pixel (Pᵢⱼ+X). Instead, each pixel may be corrected by applying thereto an amount of correction X′ derived from the following equation (2) in the first embodiment, or from the following equation (12) in the second embodiment:
X′=(X_{R}−X_{L})/2 (2)
X={(X_{R}−X_{L})}/2×α^{t} (12)

In the equation (12) above, α is less than one and t is a distance from the boundary to the pixel, as in the second embodiment.

With the amount of correction X′ derived from equation (2) or (12), when applying the amount of correction X′ to the signal level of each pixel included in the j-th pixel row and belonging to the left area L, the amount of correction X′ is added to the signal level of the pixel (Pᵢⱼ+X′). When applying the amount of correction X′ to the signal level of each pixel included in the j-th pixel row and belonging to the right area R, the amount of correction X′ is subtracted from the signal level of the pixel (Pᵢⱼ−X′). A similar correction may be performed for the vertical direction also.

(6) In the first embodiment described hereinbefore, the amount of correction X is derived from equation (1) (i.e. X=(X_{L}−X_{R})/2), and this amount of correction X is applied to the signal level of each pixel to correct the pixel. This could result in an excessive correction. Thus, as in the following equation (3), the amount of correction X may be multiplied by a fixed rate a to be made smaller. In the equation, α is less than one.
Y=α·X=α·(X_{L}−X_{R})/2 (3)

This amount of correction Y may be applied to the signal level of each pixel to correct the pixel. It has been confirmed through experiment that a at about 0.7 realizes an appropriate correction. A similar correction may be performed for the vertical direction also.

(7) In the first embodiment described hereinbefore, the amount of correction X is derived from equation (1) (i.e. X=(X_{L}−X_{R})/2), and this amount of correction X is applied to the signal level of each pixel to correct the pixel. The signal level differences appear notably near the boundary. The farther away the pixel is from the boundary, that is the longer the distance is from the boundary to the pixel, the less influence the signal level difference has on the signal level of that pixel. Thus, a correction may be made with a weighting as in the second embodiment.

That is, where the distance (i.e. the number of pixels) from the boundary B_{V} to the pixel is t as shown in FIG. 9 of the second embodiment, the smaller weight may be assigned for the longer distance t from the boundary B_{V} to the pixel, as in the following equation (4). Each pixel may be corrected by applying such statistics represented by mean values to the signal level of the pixel.
Y′=α·X/(t−α) (4)

The signal level differences between the pixels can be reduced further by applying the amount of correction Y′ derived from equation (4) to the signal level of each pixel to correct the pixel. It has been confirmed through experiment that a at about 0.02 to 0.05 realizes an appropriate correction. A similar correction may be performed for the vertical direction also.

Distance t is not limited to the number of pixels, but may be a value proportional to the number of pixels, or a value with a predetermined number added to the number of pixels.

The invention is not limited to any particular weighting modes including the weighting with the multiplication by at with a being less than one as in equation (11) in the second embodiment, or the weighting as in equation (4) in the above modification relating to the weighting of the first embodiment. For example, only distance t may be the denominator in equation (4) above. Amount of correction Y′ may be a value obtained by subtracting distance t instead of the division by distance t. The equation (11) in the second embodiment may be replaced by the following equation (13) or (14) in which a weight is assigned by making distance t a denominator:
X=(X_{L}−X_{R})/2×1/t (13)
X=(X_{L}−X_{R})/2×β/(t−β) (14)

It has been confirmed through experiment that beta at about 0.02 to 0.05 realizes an appropriate correction.

Thus, the invention is not limited to equation (4) or equation (11) noted above, as long as the smaller weight is assigned for the longer distance t from the boundary B_{V} to the pixel, and each pixel is corrected by applying such statistics represented by mean values to the signal level of the pixel.

(8) In the second embodiment described hereinbefore, the amount of correction X reflecting a weighting is calculated as in equation (11) (X={(X_{L}−X_{R})}/2×α^{t}), and the amount of correction X is applied to the signal level of each pixel to make a correction in a way to avoid an excessive correction. As long as an excessive correction is avoided, as also shown in FIG. 6 of the first embodiment, the weight may be removed from the above equation (11) as in the following equation (15):
X=(X_{L}−X_{R})/2 (15)

For removing the weight from equation (12) noted above, the mean values X_{R} and X_{L} in the above equation (15) may be interchanged. The weight may be removed similarly for the vertical direction also.

(9) In each embodiment described hereinbefore, the mean values are those of the signal levels of the 8×8 areas or 4×4 areas T_{R} and T_{L} sampled from the right and left areas R and L. Instead, mean values of the signal levels of all the pixels may be used. That is, the invention may use mean values of the signal levels of at least part of the pixels. A similar correction may be made for the vertical direction also.

(10) In each embodiment described hereinbefore, the mean values are an example of statistics relating a distribution of signal levels of the pixels. The invention is not limited to the mean values, but may use any statistics usually available. Such a statistic is, for example, a median of the signal levels, a mode of the signal levels, and a weighted mean of the signal levels. The median is a value located in a middle position in a group of values of the signal levels. The mode is a value with a maximum count in a histogram. The weighted mean is a mean value with a weight varied according to the distance from the boundary (i.e. a weighted mean value). Two or more different statistics may be combined, such as a combination of a mean value and a median.

(11) In the second embodiment described hereinbefore, the particular conditions are A: the absolute value of the difference between the mean values (X_{L}−X_{R}) is 50 or less, and B: the absolute value of the difference between the mean values (X_{L}−X_{R}) is 0.1 or less times the smaller mean value. The particular conditions are not limited to the above, as long as the absolute value of the difference between the statistics (e.g. mean values) does not exceed a predetermined value. For condition A, the predetermined value is digital value 50 (in decimal notation), but it is not limited to 50. However, even where the statistics are other than mean values, it is preferable that condition A has the absolute value of the difference between the statistics at 50 or less. In the case of a predetermined value other than 50, it is preferable to select a value from the range of 25 to 100. For condition B, the fixed multiplying factor used is 0.1 or less. However, the absolute value of the difference between the statistics may be more than 0.1 times the smaller statistic. Preferably, the fixed multiplying factor is less than one.

(12) In the second embodiment described hereinbefore, the particular conditions are A: the absolute value of the difference between the mean values (X_{L}−X_{R}) is 50 or less, and B: the absolute value of the difference between the mean values (X_{L}−X_{R}) is 0.1 or less times the smaller mean value. It is possible to use a combination of other particular conditions in which the absolute value of a difference between statistics is less than a predetermined value. Conversely, only one of conditions A and B may be used as a particular condition. Of course, a particular condition other than A and B in which the absolute value of a difference between statistics is less than a predetermined value may be used alone, and a correction process may be carried out only when this condition is satisfied.

(13) In the embodiment described hereinbefore, the particular conditions are A: the absolute value of the difference between the mean values (X_{L}−X_{R}) is 50 or less, and B: the absolute value of the difference between the mean values (X_{L}−X_{R}) is 0.1 or less times the smaller mean value. A correction process is carried out when at least one of the conditions A and B is satisfied. Instead, a correction process may be carried out only when the conditions A and B are both satisfied. This applies also to conditions other than the particular conditions A and B.

(14) In the embodiment described hereinbefore, when neither of the particular conditions is satisfied, no correction is carried out but the unchanged signal level is used as the signal level of each pixel. This is not limitative. That is, if no correction is carried out at least for locations where the absolute value of a difference between statistics should exceed a predetermined value, a process different from the described correction may be carried out. For example, when the particular conditions are not satisfied, the signal levels of all the pixels may be multiplied equally.

This invention may be embodied in other specific forms without departing from the spirit or essential attributes thereof and, accordingly, reference should be made to the appended claims, rather than to the foregoing specification, as indicating the scope of the invention.

1. A radiographic apparatus for obtaining radiographic images based on radiation detection signals, comprising:
radiation emitting means for emitting radiation toward an object under examination;
radiation detecting means for detecting radiation transmitted through said object;
statistic calculating means for calculating statistics relating to a distribution of signal levels of pixels based on said radiation detection signals, said statistic calculating means being operable, when signal level differences occur across a boundary extending horizontally or vertically of a pixel arrangement, to calculate said statistics for two areas divided by said boundary; and
pixel correcting means for performing a correction of each pixel by applying an amount of correction relating to a difference between the statistics for said two areas to a signal level of each pixel to reduce said signal level differences.

2. A radiographic apparatus as defined in claim 1, wherein said pixel correcting means is arranged to perform said correction only when a particular condition that an absolute value of said difference between the statistics is below a predetermined value is satisfied.

3. A radiation detection signal processing method for obtaining radiographic images based on radiation detection signals resulting from radiation emitted to and transmitted through an object under examination, said radiation detection signal processing method comprising the steps of:
calculating statistics relating to a distribution of signal levels of pixels based on said radiation detection signals, and when signal level differences occur across a boundary extending horizontally or vertically of a pixel arrangement, calculating said statistics for two areas divided by said boundary; and
performing a correction of each pixel by applying an amount of correction relating to a difference between the statistics for said two areas to a signal level of each pixel to reduce said signal level differences.

4. A radiation detection signal processing method as defined in claim 3, wherein said statistics are mean values of signal levels of at least part of said pixels.

5. A radiation detection signal processing method as defined in claim 3, wherein each pixel is corrected by applying said amount of correction to the signal level of each pixel, with a progressively smaller weighting with an increase in distance from said boundary to each pixel.

6. A radiation detection signal processing method as defined in claim 3, wherein said correction is performed only when a particular condition that an absolute value of said difference between the statistics is below a predetermined value is satisfied.

7. A radiation detection signal processing method as defined in claim 6, wherein said correction is omitted and the signal level of each pixel is left unchanged when said particular condition is unsatisfied, the signal level left unchanged being used as signal level of each pixel.

8. A radiation detection signal processing method as defined in claim 6, wherein said statistics are mean values of the signal levels, said particular condition being that an absolute value of a difference between said mean values is at most 50.

9. A radiation detection signal processing method as defined in claim 6, wherein said particular condition is that said absolute value of said difference between the statistics has at most a fixed ratio to the smaller of said statistics for said two areas.

10. A radiation detection signal processing method as defined in claim 6, wherein said statistics are mean values of the signal levels, said particular condition being that an absolute value of a difference between said mean values is at most 0.1 times the smaller of the mean values.

11. A radiation detection signal processing method as defined in claim 6, wherein said statistics are mean values of said signal levels.

12. A radiation detection signal processing method as defined in claim 6, wherein said statistics are medians of said signal levels.

13. A radiation detection signal processing method as defined in claim 6, wherein said statistics are modes of said signal levels.

14. A radiation detection signal processing method as defined in claim 6, wherein said statistics are weighted mean values of said signal levels.

15. A radiation detection signal processing method as defined in claim 6, wherein a process other than said correction is carried out when said particular condition is unsatisfied.

16. A radiation detection signal processing method as defined in claim 6, wherein each pixel is corrected by applying said amount of correction to the signal level of each pixel, with a progressively smaller weighting with an increase in distance from said boundary to each pixel.

17. A radiation detection signal processing method as defined in claim 6, wherein a plurality of particular conditions are provided, and said correction is performed when at least one of the particular conditions is satisfied.

18. A radiation detection signal processing method as defined in claim 6, wherein a plurality of particular conditions are provided, and said correction is performed only when all of the particular conditions are satisfied.

19. A radiation detection signal processing method as defined in claim 6, wherein said correction is performed for locations where said boundary crosses a structure of said object.

20. A radiation detection signal processing method as defined in claim 19, wherein said correction is performed for locations where said boundary crosses body lines of said object.
